(19) United States
(12) Patent Application Publication
(10) Pub. No.: US 2014/0094238 A1
(43) Pub. Date: Apr. 3, 2014

(54) Card Game

(71) Applicants: Justin Robert Huxley, West Pymble (AU); Simon Witty, Mosman (AU)

(72) Inventors: Justin Robert Huxley, West Pymble (AU); Simon Witty, Mosman (AU)

(73) Assignee: TCS John Huxley Europe Ltd., London (GB)

(21) Appl. No.: 14/023,596

(22) Filed: Sep. 11, 2013

Related U.S. Application Data
(60) Provisional application No. 61/707,453, filed on Sep. 28, 2012.

(51) Int. Cl. A63F 1/00; G07F 17/32

(52) U.S. Cl. CPC A63F 1/00; G07F 17/3244
USPC 463/12; 273/292

(57) ABSTRACT

A card game is described in which two hands of cards are dealt, and players are invited to wager on whether one hand or the other will win, or whether the hands will tie. The hands may initially be formed from two cards each, and further cards may be added to the hands on the basis of a predetermined dealing tableau. Determination of the winner may be on the basis of a modified blackjack scoring system which provides for a winner even if both hands have totals over 21. In an alternative embodiment, the initial hands are formed from five cards each and the winning hand is determined by determining ascribing a rank value to the five-card combination and determining that the winning hand is the hand with the higher rank value. In some embodiments, the rank value may represent the highest-ranking poker hand which can be formed from the cards of each hand, and the winner will be the hand from which the higher-ranking poker hand can be formed. Rank values may be ascribed to 5-card combinations on the basis of other criteria or characteristics of the five-card combination.

### RELATED APPLICATIONS

This application claims the benefit under 35 U.S.C. §119(e) of U.S. Provisional Application Ser. No. 61/707,453, filed Sep. 28, 2012, which is incorporated herein by reference in its entirety.

### TECHNICAL FIELD OF THE INVENTION

This disclosure relates to card games, and particularly provides a card game in which many players can simultaneously wager on the outcome of a game.

### BACKGROUND

Baccarat and Blackjack are popular card games played in casinos (or other gaming venues) and online, and have relatively simple card dealing and wagering rules with easily understood rules for valuing and ranking of hands.

### Baccarat

In the game of Baccarat, players traditionally have three possible outcomes on which players can wager, i.e. player, banker and tie. In Baccarat, one player plays against the banker so that only two hands of cards are in play, and the players bet on which hand will have a score closer to 9. Each of the cards from ace to nine has a point value equal to its rank or spot value, and the remaining cards (ten, jack, queen, and king) have a point value of zero. The point value of hands in Baccarat is determined by summing modulo ten the point value of the constituent cards. Taking the total modulo ten means disregarding the first digit in any total of ten or more. For example, a hand consisting of a three and a four is worth seven (3+4=7). A hand consisting of a seven and a nine is worth six (7+9=16, the first digit being dropped as the total is higher than ten to give a total of 6). A hand consisting of a six and a four is worth zero (6+4=10, the first digit being dropped to give a total of 0). In Baccarat, there are a total often ranked hand totals with the highest ranked being any two or three card combination having a total (or sum modulo ten) that totals nine. The total number of cards used to obtain the total is irrelevant, and as such, a two-card total of nine has the same ranking as a three-card total of nine.

Conventional baccarat rules do not allow for player participation or require additional decision making once the game begins, as a standard series of rules known as the tableau governs the outcome of each game. The tableau determines when a two-card total for either the player's or the banker's hand must either stand or draw another card.

### Blackjack

In blackjack, each player receives his own individual hand, and each player in turn plays his hand with the objective of improving his score. The player's objective is to obtain a hand which is closer to twenty one (21) than the hand of the dealer, without going over twenty one (21). When all of the players have the played their hands, a dealer's hand is played in order to determine which player (if any) has beaten the dealer's hand and has therefore won in that deal.

In blackjack, each of the cards from two to ten has a point value equal to its rank or spot value, with the jack, queen and king having the same rank and spot value as the ten. The ace is unique in that it can have a value of either one or eleven. The point value of hands in blackjack is obtained by adding all the cards together. For example, seven and five is worth twelve (7+5=12). A hand consisting of five and a jack is worth fifteen (5+jack=15). A hand consisting of an ace and a four can be either a five or fifteen (ace+4=5 or 15), because an ace can have a total of either one or eleven. If the ace is valued as 11, then this is termed a “soft 15” to distinguish it from, say, a 9 and a 6 which makes a “hard 15”.

In blackjack, a hand begins with each player placing a bet, they are then each dealt two cards which can be either face up or face down, and the dealer is dealt one or two cards, one of which is exposed. Each player in turn must then decide if he wishes to “stand”, keeping only his original two cards, or to draw one or more additional cards to add to his initial two card hand, to bring the total closer to twenty one. If a player's hand total exceeds twenty one, the player is “bust” and loses his wager. At this point, the player's interest in the game is at an end until the next deal, as he has no further possibility of winning during this round of play.

When all of the players have completed their play and either “stand” with a total of 21 or fewer or have gone “bust”, the dealer receives a second card (if necessary) and the dealer's two cards are exposed. The dealer then completes his hand according to a tableau which determines whether the dealer must stand, or must draw. Typically, the dealer must draw to a hand that has a combined value of 16 or fewer points, and must stand if the combined value is 17 or more.

When the dealer has completed his hand, and “stands” on a value of 21 or less, then those players whose hand total is closer to 21 than the dealer's are declared winners and are paid their stake. If the dealer's hand goes “bust” then all remaining players who have “stood” on values of 21 or less are paid.

One of the major drawbacks for players who play blackjack is the decision-making process. Because blackjack is a dynamic game wherein players have the option to either stand or to draw to their initial hand and take one or more cards, players often have the tendency to pass judgment on the choices of other players based on a perception of events that may or may not have happened based on these decisions. For example, the last player to act in blackjack is often criticized for his decisions, as he is the last player to act prior to the dealer completing the dealer hand.

If for example a player in the last position were to be dealt an initial two card hand with a total of twelve (12) and the dealer were showing an exposed card of four (4), then if the player decided to draw a third card and drew an eight (8) it would make his point total twenty. If the dealer completed his hand by drawing a second card of say a ten (10) and then a third card of a seven (7) making twenty one (21), then the dealer's hand would beat all of the surviving (i.e. non-“bust”) players and no player would be paid out. The last player could experience (possibly unreasonable) criticism because, if he had chosen to “stand” on 12 and not draw a third card, the dealer would have received an eight (8) and then a ten (10) making a total of twenty two (22) and busting, therefore ensuring that all surviving players would win.

In Baccarat, the game play for both hands is controlled by a tableau and as such, players are not required to exercise their decision making ability. Players have no control on the outcome of the hand once the game begins. This generally means that players are less inclined to criticize other players at the table because of the way they played.

Another major drawback for players of blackjack is the fact that when they draw cards to their hand and obtain a total greater than twenty one (21), their hand is declared a bust and all wagers associated with that hand are forfeited to the house. In the conventional blackjack game, as soon as a player's hand has gone “bust” he is effectively out of the game until the next deal.

### SUMMARY

According to a first aspect of the present disclosure, there is provided a method for playing a card game which includes receiving wagers from a number of players, dealing cards to form two initial hands, applying the rules of a dealing tableau to the initial hands to produce two final hands, establishing a result of the deal by determining, using hand rankings similar to blackjack, whether one or the other of the final hands is the winner or whether there is a tie, and paying out on winning wagers. Applying the rules of the dealing tableau may result in a final hand being the same as its initial hand, or may result in the final hand including one or more additional cards to those of the initial hand. The final hands are reached by applying the rules of the dealing tableau to the two initial hands, and not by decisions of any of the players.

Players wager on whether one hand or the other will be determined to win, or whether the result will be a tie, after both hands have followed the dealing decisions laid down in the dealing tableau. An important difference from blackjack is that players do not each have “their own” hand to play against the “dealer” hand, and do not make their own dealing decisions. In the game of the present disclosure, only two hands are dealt irrespective of how many players are placing wagers, and each player can choose to wager on either hand to be a winner, or can wager on the result being a tie between the two hands.

In one example of the game of the present disclosure, the dealing tableau that is applied to the initial hands to obtain the final hands is structured to be similar to the tableau applied to the dealer's cards in Blackjack, in that both hands must draw another card if the hand totals sixteen (16) or less, and stand on any total which is seventeen (17) or greater. In some examples, a hand does not draw to totals of soft seventeen, i.e. a hand total that features an ace and a six.

Other tableaux are foreseen, however. For example the tableau may require each hand to stand on a total of 18 points or more, and draw on a total of 17 or fewer points. The tableau may distinguish between a “soft seventeen” and a “hard seventeen” and may require a hand to stand on a hard seventeen but draw on a soft seventeen, or vice versa.

According to a second aspect of the present disclosure, there is provided a method for playing a card game which includes receiving wagers from a number of players, dealing cards to form two hands of five cards each, establishing a result of the deal by determining whether one or the other of the hands is the winner, using hand rankings as in poker, and paying out on winning wagers. The players wager on one hand or the other to win. The result may be established by a process including the steps of determining the highest-ranking poker hand which can be made from the five cards dealt to each respective hand, and then by determining which of the hands results in the higher-ranking poker hand. Alternatively, each combination of five cards from a standard 52-card deck may be recorded in a table, with a corresponding rank. The rank may be based on the highest-ranking poker hand which can be formed from those five cards, or on some other characteristic of the five-card combination. The result of the deal may be determined by looking up the combination of cards which have been dealt to each hand, comparing their respective ranks, and determining that the hand with the higher rank is the winner. If a table is used in which two different combinations of five cards have the same rank, then the players may be given the option of betting on a “tie” as well as the options of betting on one or the other hand to be determined the winner.

The methods of these first and second aspects may be implemented as a live table game, where physical cards are dealt on a table either by a dealer in person or by a card dealing machine, and players present can place wagers on the outcome of the game. Alternatively, the methods may be implemented as an electronic gaming application, either played online via a fixed or a mobile device, or on a dedicated gaming machine for example at a casino.

A third aspect of the present disclosure provides a machine-readable storage medium having instructions stored thereon which, when executed by a processor, cause the processor to perform operations including receiving wagers, dealing cards to form two initial hands of two cards, playing the hands on the basis of a stored dealing tableau to generate two final hands, and determining a result of the deal by determining one or other of the final hands hand to be a winner or declaring a tie, on the basis of hand rankings similar to Blackjack. Wagers received from players are then paid out on the basis of the determined result.

A fourth aspect of the present disclosure provides a machine-readable storage medium having instructions stored thereon which when executed by a processor causes the processor to perform operations including receiving wagers, dealing two hands of five cards, and determining a result of the deal by determining one or other hand to be a winner, on the basis of poker hand rankings. Wagers received from players are then paid out on the basis of the determined result. In some embodiments, the instructions may provide for the step of determining the result of the deal to include the possibility of determining a tie, as well as the possibilities of determining one or other hand to be a winner.

A fifth aspect of the present disclosure further provides an electronic device including a user input, a display, a processor, and a memory having instructions therein which when executed by the processor perform operations which include receiving wagers via the user input and displaying cards to form two initial hands of two cards each, displaying modifications to the hands on the basis of a stored dealing tableau to generate two final hands, and determining a result of the deal by determining one or other hand to be a winner or declaring a tie, on the basis of hand rankings similar to Blackjack, and resolving the wagers.

A sixth aspect of the present disclosure provides an electronic device including a user input, a display, a processor, and a memory having instructions therein which when executed by the processor perform operations which include receiving wagers via the user input and displaying cards to form two poker hands, and determining a result of the deal by determining one or other hand to be a winner or declaring a tie on the basis of poker hand rankings, and resolving the wagers.

A seventh aspect of the present disclosure provides an electronic gaming system comprising a plurality of gaming terminals and a game server linked to the terminals via a communications network, the game server including a processor, and a memory having instructions therein which, when executed by the processor, include receiving wagers via inputs at the user terminals, generating and displaying at the user terminal cards to form two initial hands of two cards each, displaying modifications to the hands on the basis of a stored dealing tableau to generate two final hands, and determining a result of the deal by determining one or other hand to be a winner or declaring a tie on the basis of modified blackjack hand rankings, and resolving the wagers.

An eighth aspect of the present disclosure provides an electronic gaming system comprising a plurality of gaming terminals and a game server linked to the terminals via a communications network, the game server including a processor, and a memory having instructions therein which, when executed by the processor, include receiving wagers via inputs at the user terminals, generating and displaying at the user terminal cards to form two poker hands, and determining a result of the deal by determining one or other hand to be a winner or declaring a tie on the basis of poker hand rankings, and resolving the wagers.

The electronic device or the gaming terminal can be selected from a computer, an electronic game table, a gaming machine, a mobile phone, a tablet or pad computer, and a smartphone. The game server may be a network device other than a server, and may for example be a desktop or laptop computer.

An advantage of the present disclosure is that the object of the game is to predict, and bet on, one of two blackjack hands that is closer to twenty one (21) than the other hand, even if the totals of both hands are greater than twenty one (21). This feature allows for an additional level of player satisfaction not experienced in traditional blackjack games. The player's interest in the game is therefore maintained throughout the round of play until the last card is played, because even if the hand on which a player has bet goes “bust”, there is still a possibility that the player could win if the other hand goes “bust” by a larger amount.

### BRIEF DESCRIPTION OF THE DRAWINGS

Embodiments of the present disclosure will now be described by way of example only with reference to the accompanying drawing, in which:

FIG. 1 is a diagram illustrating a method for playing a card game with hybrid rules according to one embodiment of the present disclosure.

FIG. 2 is a flow chart illustrating the steps by which the result of the game is determined.

FIG. 3 is a plan view of a table adapted for playing the game.

FIG. 4 is a schematic illustration of a gaming system for playing the game according to the disclosure.

FIG. 5 is a schematic illustration of a gaming machine.

FIG. 6 is an example of a screen display for a gaming machine or terminal.

### DETAILED DESCRIPTION

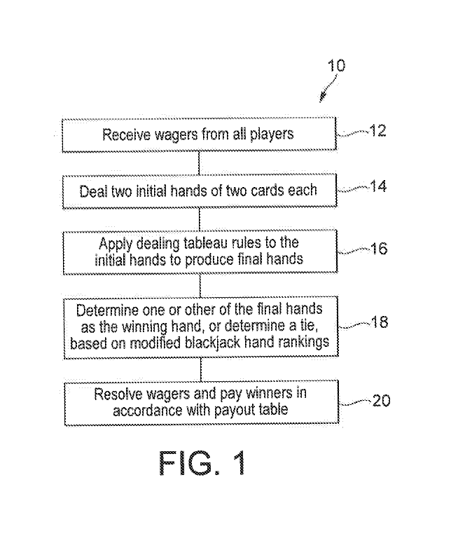

FIG. 1 illustrates a method 10 for playing a “blackjack-type” card game with hybrid rules according to one embodiment of the first aspect of the present disclosure. The method starts at step 12 by receiving wagers from one or more players, each wager including a result element selecting one or other of the hands to be a winning hand, or selecting a tie, and an amount element indicating a monetary or other value for the wager. The wagering rules may optionally allow secondary, side or jackpot bets, such as progressive jackpot bets, to be made by players in the manner of secondary, side or jackpot wagering in poker and blackjack. In “real-world” games, wagers may be made by placing actual cash or gambling chips on a betting area of a gaming table, or by inserting cash or tokens into a gaming machine.

When all players have placed their wagers, the method moves onto step 14 where two initial hands of two cards are dealt from a pack containing one or more decks of standard playing cards. The cards can be dealt from either a single 52 card deck, or from a stack of cards comprising multiple decks, with or without jokers.

The method 10 then moves to step 16 where each hand will subsequently either draw additional cards or stand. The decision whether to draw cards or to stand will be based on a dealing tableau, which sets out the action to be taken for each card total. The tableau may be based on the blackjack style dealing tableau of Table 1 below.

TABLE 1
Dealing Tableau 1

| Hand total | 16 or fewer | 17 or more |
|---|---|---|
| Action | Draw a card | Stand |

Using this dealing tableau, any hand that has a total of sixteen (16) or lower will draw an additional card. If the hand total is still less than 16 after a card has been drawn, then one or more further cards are drawn until the hand total exceeds 16. Any initial hand that has a total of seventeen (17) or higher will stand.

Alternatively, the dealing tableau may distinguish between a total of 17 comprising an ace and a 6 (“Soft 17”) and a total of 17 arrived at without an ace, for example by a 9 and an 8 (“Hard 17”), as follows in the example of Table 2 below.

TABLE 2
Dealing Tableau 2

| Hand total | 16 or fewer | Soft 17 | Hard 17 or more |
|---|---|---|---|
| Action | Draw a card | Draw a card | Stand |

Applying the rules of the dealing tableau to both of the initial hands produces two “final hands” of cards, each final hand including two or more cards and totaling more than 16.

The method 10 then moves on to step 18, in which the result of the deal is determined, based on modified blackjack hand rankings, to declare either one or the other of the final hands as the winning hand, or to declare a tie. If both of the final hands have the same total, then the result is a tie. If the final hands have different totals but are both 21 or less, then the hand whose total is nearer 21 is the winner. If one of the final hands has a total over 21 and the other has a total of 21 or fewer, then the hand with the lower total wins. If both hands have totals over 21, then again the hand with the lower total (i.e. the nearest to 21) wins. The result of the deal may be determined on the basis of the game determination table set out in Table 3 below.

TABLE 3

| | | Hand 1 | | | | | | | | | |
|---|---|---|---|---|---|---|---|---|---|---|---|
| | | 17 | 18 | 19 | 20 | 21 | 22 | 23 | 24 | 25 | 26 |
| Hand 2 | 17 | Tie | 1 | 1 | 1 | 1 | 2 | 2 | 2 | 2 | 2 |
| | 18 | 2 | Tie | 1 | 1 | 1 | 2 | 2 | 2 | 2 | 2 |
| | 19 | 2 | 2 | Tie | 1 | 1 | 2 | 2 | 2 | 2 | 2 |
| | 20 | 2 | 2 | 2 | Tie | 1 | 2 | 2 | 2 | 2 | 2 |
| | 21 | 2 | 2 | 2 | 2 | Tie | 2 | 2 | 2 | 2 | 2 |
| | 22 | 1 | 1 | 1 | 1 | 1 | Tie | 2 | 2 | 2 | 2 |
| | 23 | 1 | 1 | 1 | 1 | 1 | 1 | Tie | 2 | 2 | 2 |
| | 24 | 1 | 1 | 1 | 1 | 1 | 1 | 1 | Tie | 2 | 2 |
| | 25 | 1 | 1 | 1 | 1 | 1 | 1 | 1 | 1 | Tie | 2 |
| | 26 | 1 | 1 | 1 | 1 | 1 | 1 | 1 | 1 | 1 | Tie |

“1” indicates hand 1 wins;
“2” indicates hand 2 wins.

For example, as can be seen from Table 3, if both hand 1 and hand 2 have 18 points, the result is “Tie”. If, however, hand 1 has 19 points and hand 2 has 18, the result is that hand 1 wins. If hand 1 goes “bust” with a total over 21 and hand 2 has 21 points or fewer, then hand 2 wins. If both hands go “bust” then the hand with the total nearest to 21 is the winner, for example if hand 1 has 24 points and hand 2 has 22 points, then hand 2 is the winner.

It is further foreseen that the game determination table may be modified so as to discriminate between a score of 21 where the hand comprises an ace and a picture card (otherwise known as a “blackjack”) and a score of 21 where the hand comprises either an ace and a ten, or comprises three or more cards totaling 21. In such cases, the game determination table may be structured so that a blackjack will win over any other score of 21. Table 4 shows a game determination table in which a “blackjack” (BJ) is distinguished from a score of 21.

TABLE 4
Game determination table

| | Hand 1 | | | | | | | | | | |
|---|---|---|---|---|---|---|---|---|---|---|---|
| Hand 2 | 17 | 18 | 19 | 20 | 21 | BJ | 22 | 23 | 24 | 25 | 26 |
| 17 | Tie | 1 | 1 | 1 | 1 | 1 | 2 | 2 | 2 | 2 | 2 |
| 18 | 2 | Tie | 1 | 1 | 1 | 1 | 2 | 2 | 2 | 2 | 2 |
| 19 | 2 | 2 | Tie | 1 | 1 | 1 | 2 | 2 | 2 | 2 | 2 |
| 20 | 2 | 2 | 2 | Tie | 1 | 1 | 2 | 2 | 2 | 2 | 2 |
| 21 | 2 | 2 | 2 | 2 | Tie | 1 | 2 | 2 | 2 | 2 | 2 |
| BJ | 2 | 2 | 2 | 2 | 2 | Tie | 2 | 2 | 2 | 2 | 2 |
| 22 | 1 | 1 | 1 | 1 | 1 | 1 | Tie | 2 | 2 | 2 | 2 |
| 23 | 1 | 1 | 1 | 1 | 1 | 1 | 1 | Tie | 2 | 2 | 2 |
| 24 | 1 | 1 | 1 | 1 | 1 | 1 | 1 | 1 | Tie | 2 | 2 |
| 25 | 1 | 1 | 1 | 1 | 1 | 1 | 1 | 1 | 1 | Tie | 2 |
| 26 | 1 | 1 | 1 | 1 | 1 | 1 | 1 | 1 | 1 | 1 | Tie |

For example, as can be seen from Table 4, if both hand 1 and hand 2 have blackjack, the result is “Tie”. If, however, hand 1 has 21 points and hand 2 has blackjack, the result is that hand 2 wins.

The result of the deal is similar to a game of blackjack, except that a hand which exceeds 21 may still be a winning hand, if the other hand exceeds 21 by a larger margin. This difference maintains the interest of a player who has a bet on hand 1 if hand 1 goes bust, because he still has a chance of winning if hand 2 also goes bust. The player who has bet on hand 1 also has a chance of his stake being returned, in the event of a tie. The interest of the player who bet on hand 1 is thus maintained until the final card of hand 2 is revealed.

The final step 20 in the method is to resolve the wagers placed by the players and pay winners. The amount won by a player placing a winning bet may depend on the total scores of the two final hands, and may be determined in accordance with a payout table. Examples of payout tables for winning bets selecting one or other of the hands to win are set out below in Tables 5 and 6. An example of a payout table for winning bets which select the option “Tie” is set out in Table 7.

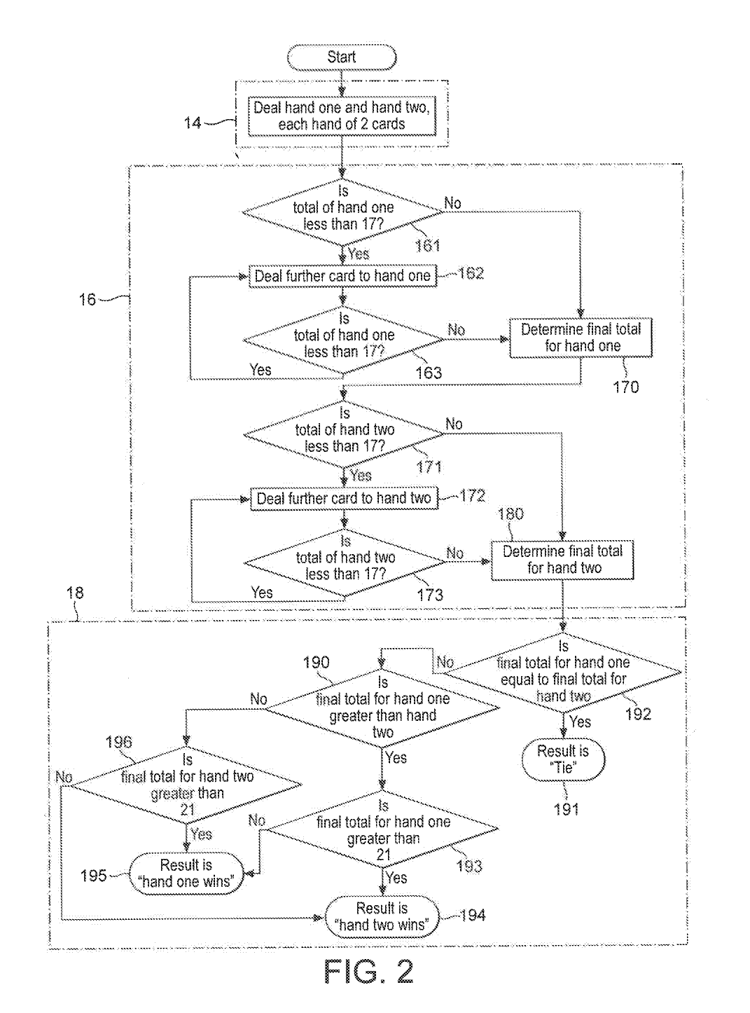

The flowchart of FIG. 2 illustrates the process by which the steps 14, 16 and 18 of the method of FIG. 1 may be carried out in one example. The dealing step is seen in box 14, which corresponds to step 14 of FIG. 1.

Box 16 shows the process steps in applying the dealing tableau to the initial hands of cards to arrive at the final hands. The dealing tableau is first applied to hand 1 by first determining, at step 161, whether the total of the initial hand is less than 17. If it is not, the process flows to step 170, and the final total of hand 1 is determined as being its initial total. If the initial total of hand 1 is less than 17, the process proceeds to step 162 and a further card is dealt to hand 1. The new total of hand 1 is calculated and at step 163 it is determined whether this new total is less than 17. If it is, the process returns to step 162 and a further card is dealt to hand 1. When the total of hand 1 exceeds 16 (i.e. is 17 or more) then the process proceeds to step 170 and the final total of hand 1 is determined.

The process then proceeds to apply the same steps to hand 2, at process steps 171, 172, 173 and finally step 180 where the final total for hand 2 is determined. Box 18 represents the process steps for determining the result of the deal, using the modified blackjack card rankings set out in Table 3. At step 190 it is first determined whether the final totals for the two hands are equal, and if they are then the process moves to step 191 and the result is declared as a tie.

If the final totals for the two hands are not equal, the process moves to step 192 and it is determined whether the total of hand 1 is greater than that of hand 2.

If it is determined at step 192 that hand 1 has a total greater than that of hand 2, the process moves to step 193 and it is determined whether hand 1 has a total greater than 21.

If it is determined at step 193 that the total for hand 1 is greater than 21, then the process moves to step 194 and the result is declared that hand 2 is the winner.

If it is determined at step 193 that the total for hand 1 is less than 21, then the process moves to step 195 and the result is declared that hand 1 is the winner.

If it is determined at step 192 that hand 1 has a total less than that of hand 2, the process moves to step 196 and it is determined whether hand 2 has a total greater than 21.

If it is determined at step 196 that the total for hand 2 is greater than 21, then the process moves to step 195 and the result is declared that hand 1 is the winner.

If it is determined at step 196 that the total for hand 2 is less than 21, then the process moves to step 194 and the result is declared that hand 2 is the winner.

The method of the present disclosure can be implemented as a live table game in a casino (or other gaming venue) and performed manually using physical cards, non-electronic gaming tables and physical wagering chips. The method may also be implemented in computer software and performed electronically using virtual playing cards on a networked or standalone electronic device selected from computers, electronic game tables, gaming machines, mobile phones, and smartphones. Other equivalent electronic devices may also be used. The method may also be implemented partly manually and partly electronically, for example, on a hybrid electronic gaming table with physical cards.

The method of the present disclosure may also be implemented as an online gaming application in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combinations of such back-end, middleware, or front-end components. The components of the system may be interconnected by any form or medium of digital data communication (e.g., a communication network). Examples of communication networks include a local area network (“LAN”), a wide area network (“WAN”), and the internet.

According to a second aspect of the present disclosure, there is provided a method of playing a card game in which the winning hand is determined using poker hand rankings, rather than the modified blackjack hand rankings described above. According to this second aspect, the method is modified so that steps 14 and 16 of dealing initial hands and modifying the initial hands to form final hands are replaced by a single step in which two hands are dealt, and these hands are the final hands for this round of play. Each of the hands consists of five cards rather than two cards. In step 18 a determination is made to identify one of the final five-card hands as the winning hand, or to declare a tie, on the basis of poker hand rankings. The ranking accorded to each of the final hands may be based on the highest-ranking poker hand which can be formed from the five cards of the final hand. In this aspect of the present disclosure, players may be invited to place a wager on one hand or the other hand, and may not be offered the option of betting on a “tie”. The game determination table for the poker-based game may comprise a look-up table which allocates a different ranking to every possible 5-card combination, so that the occurrence of a tie is avoided if the game is played with only a single deck of cards. Alternatively, if multiple decks of cards are used to form the dealing pack, the possibility exists that two identical hands will be dealt and a tie can occur, even if every combination of five cards has been allocated a different ranking value. In such cases, the player will be offered three betting options which include the option of betting on a “tie”.

In a further alternative embodiment, the first and second hands may be allocated hand rankings on the basis of a table of rankings whereby different hands are categorized into separate sections or groups. For example, a 5-card poker hand comprising of K-J-8-4-3 could be ranked as “King high”, and Q-J-8-4-3 could be ranked as “Queen high”. In traditional poker rankings, the King high hand would win over the Queen high hand, but it is also foreseen that a hand ranking table for 5-card hands could be compiled in which ranking values are based on other characteristics of the five-card hand. The hands may be grouped so that in the previous two examples, these exemplary hands would both be ranked as “No Pair”, giving rise to the possibility that they are a Tie. Other groups, such as combinations of five cards with “no picture card”, “all same color” or “all odd numbers” might also be given hand ranking values. Using such a table of rankings may require that a pay table be used which reflects the different probabilities of the three betting options. Either traditional poker hand rankings, or other predetermined hand rankings, or a combination of traditional poker hand rankings and other arbitrarily assigned rankings may be compiled to generate the hand ranking table.

Examples of the present disclosure, which are illustrative only and are not intended to limit the scope of the disclosure, will now be described in more detail.

### Example 1

In a casino live table game example, players place their wagers on either one hand or the other being the one closest to twenty one (21) in a similar fashion to blackjack hand rankings.

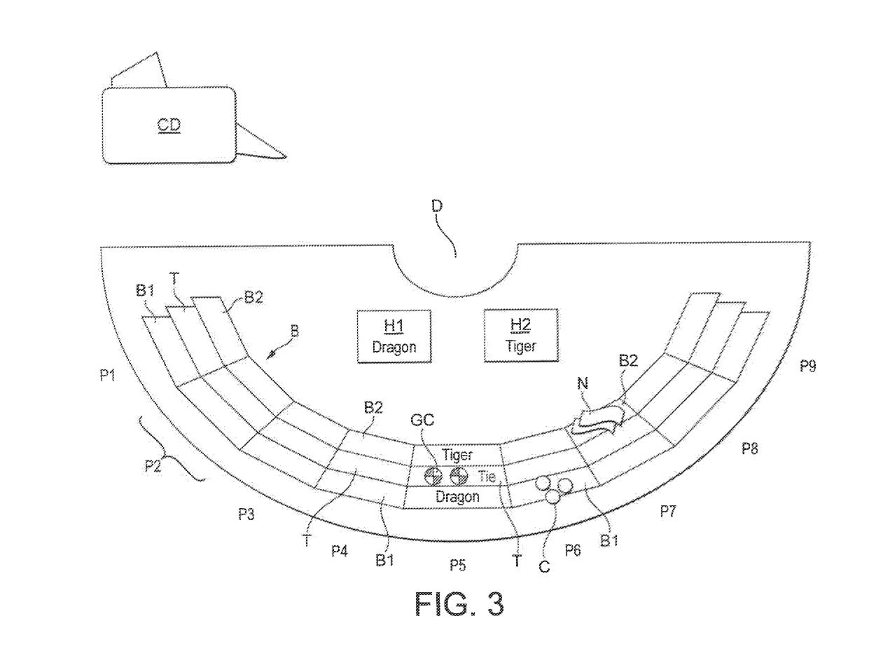

The table game is played on a generally semicircular table 30, seen in plan view in FIG. 3. The table has a generally curved edge 31 and a generally straight edge 32. A number of playing positions P1, P2, . . . P6 are spaced around the curved edge 31 of the table, and a dealer position D is defined at the centre of the straight edge 32, possibly by a slight recess in the straight edge. Conveniently, in front of the dealer position D, two dealing areas H1 and H2 are provided on the table, into which areas respective hands of cards will be dealt. The dealing areas H1 and H2 may be formed by depressions in, or raised areas of, the tabletop, or may simply be delineated on the surface of the table by lines or raised ridges, by an area of contrasting color, or in any other suitable manner.

The cards are dealt, in this embodiment, from a card shuffling and dealing apparatus CD, which sequentially delivers randomly-selected cards from a supply of cards held within the apparatus. Alternatively, a conventional shoe containing a specified number of standard decks may be used. A dealing shoe with more or fewer decks of cards may also be used, or the dealer may simply hold a pack of cards in his hands and deal cards manually.

The player's objective is to bet on the winning hand, the winning hand being determined by modified blackjack hand rankings.

Each player position has a betting area B on which the player may place cash or gambling chips to the value of his chosen bet. Each betting area B is divided into 3 regions B1, B2 and T, providing three alternative options: a player may place cash or gambling chips on region B1 of his betting area B to indicate a bet that hand 1 will win, or he may place cash or gambling chips on region B2 of his betting area B to indicate a bet that hand 2 will win, or he may place cash or gambling chips on region T of his betting area B to indicate a bet that the game will result in a tie. For example, the hand corresponding to dealing area H1 may be designated the “Dragon” hand while the other hand (corresponding to dealing area H2) is designated the “Tiger” hand, and thus the player's options are to bet on “Dragon”, “Tiger” or “Tie”. The 3 regions of the players betting area B may thus be marked “Dragon”, “Tiger” and “Tie”, respectively, as shown at player position p* in FIG. 3. Alternative names to “Dragon” and “Tiger” are of course possible, such as “Stars” and “Stripes”, “Gold” and “Silver”, “Diamonds” and “Pearls” or “Yin” and “Yang”. In the example illustrated in FIG. 3, the player at player position P5 has placed gambling chips GC on the central region T of his betting area B, to signify a bet of 2 chips on the result “tie”. The player at playing position P6 has placed 3 coins C on the outer region B1 of his betting area B, to signify a bet to the value of the coins on the result that hand 1, the “Dragon” hand, will win. The player at playing position P7 has placed to banknotes N on the inner region B2 of his betting area B, to signify a bet to the value of the notes on the result that hand 2, the “Tiger” hand, will win.

After all players have placed their bets, the dealer will deal two cards into each of the dealing areas H1 and H2. The dealer may always commence the deal by dealing the first card to a predetermined dealing area, for example by always dealing the first card to the H1 dealing area associated with the “Dragon” hand.

In another embodiment, deals may be started alternately by dealing the first card to the “Dragon” hand dealing area H1 on one deal, and then to the “Tiger” hand dealing area H2 on the next deal.

In a yet further alternative, the hand which receives the first card of a deal may be determined randomly, such as by flipping a coin or by throwing a six-sided die which has three sides marked to indicate one dealing area and the other three sides marked to indicate the other dealing area.

In a yet further alternative, the opportunity to choose which dealing area will receive the first card may be given to one or other of the players, or may be auctioned among the players, with the highest bidder paying an amount, for example into a prize fund, and determining where the first card will be dealt. In a further alternative, the player placing the largest wager may be given the choice of which dealing area will receive the first card.

Once the first card has been dealt into one dealing area H1, the second card will be dealt to the other dealing area H2 and then the dealing area H1 will be dealt a second card followed by the final card in the deal being dealt to the other dealing area H2.

The cards may be dealt face up, so that the players can clearly see the values of the cards of the initial hands, as they are dealt.

If the cards have been dealt face up, the dealer first selects one of the hands and applies the rules of the dealing tableau to add further cards if necessary until the hand can “stand”. The dealer then selects the other of the hands and likewise applies the rules of the dealing tableau until the hand can “stand”. The final values of both hands are thus determined.

Alternatively, the cards may be dealt face down, for example in the case of high limit games, in order to impart a “ceremonial” aspect to the game. In such games, the dealer will deal the four cards forming the two initial hands face down, and will select a player at the table to expose the cards of one of the hands. The dealer will then either add further cards in accordance with the dealing tableau or will determine that the hand will “stand”. In the dealing tableau of Table 1, if the hand ranking is seventeen (17) or higher the hand will “stand”, and if the total is sixteen (16) or lower cards will be drawn until the total exceeds 16.

The dealer will then select either the same player or a different player to expose the cards of the other initial hand, and in accordance with the dealing tableau the dealer will either add further cards or determine that that hand will “stand”. Again, using the dealing tableau of Table 1 as an example, if the hand ranking is seventeen (17) or higher the hand will “stand”, and if the total is sixteen (16) or lower cards will be drawn until the total exceeds 16.

The selection of a player to expose the cards of one of the initial hands may be auctioned among the players, with the highest bidder paying an amount, for example into a prize fund and determining which player will be selected to expose the cards. The selected player may expose not only the initial two card hand, but also further cards dealt in accordance with the dealing tableau. In a further alternative, the player selected to expose the cards may be determined by the player who has placed the highest wager on that particular hand result. For example, the player who has placed the highest wager on the outcome that the hand dealt into dealing area H1 will win may be the player who will expose the cards of that hand, and subsequently the player who has placed the highest wager on the outcome that the hand dealt into dealing area H2 will win may be the player who will expose the cards of that hand. The player who has placed the highest wager may be the player who exposes the cards, or may be given the opportunity to select another player to expose the cards.

The determination of which hand is first to act (i.e. the first-hand to be completed using the rules of the dealing tableau) may be determined by the order in which the first cards of the initial hands were dealt.

In a further alternative variant of the game, the dealer may deal the two initial hands face down into the dealing areas H1 and H2 before any player has placed a bet, and may then invite players to place bets on the initial hands already dealt. After the cards have been dealt and players have been given an opportunity to place wagers, the dealer may declare that no further bets will be accepted, and turn over the cards of one of the hands to commence the play.

Once the final values of both hands have been determined, the result of the deal is declared in accordance with the modified blackjack hand rankings set out in the results table being used for the game (for example Table 3 or Table 4 above). According to the results determination of Table 3:

If both hand totals are twenty one (21) or less, then the result is that the hand that is closest to twenty one (21) wins.

If one hand has a total which is less than twenty one (<21) and the other hand has a total which is greater than twenty one (>21) then the result is that the hand with the total that is less than twenty one (<21) wins.

If both hands have totals are greater than twenty one (>21) then the result is that the hand with the total that is closest to twenty one wins.

If both hands have the same total, the result is a tie.

Wagers placed by the players are then resolved, in accordance with a predefined payout table. Examples of payout tables for bets which predict one or the other hand to win are set out below in Table 5 and Table 6:

TABLE 5
“Hand to win” bets

| Result | Payout |
|---|---|
| Win with 17 | Push |
| Win with 18, 19, 20 or 21 | 1 to 1 |
| Tie | Push |
| Win with Blackjack | 3 to 2 |
| Win with >21 (more than 21) | 1 to 1 |

For example, if a player wagers 10 dollars on the “Dragon” hand to win, and the Dragon hand wins with a score of 17, then the result is a “push” and the player's stake is simply returned. With the same bet, if the Dragon hand wins with a score of 18, 19, 20 or 21 then the player receives 20 dollars (his 10 dollar stake+10 dollars winnings). Again with the same bet, if the Dragon hand wins with a blackjack then the player receives 25 dollars (his 10 dollar stake+15 dollars winnings). If the Dragon hand wins but with a score of more than 21, then the player receives 20 dollars (his 10 dollar stake+10 dollars winnings). Finally, if the player has bet on a win for either the “Dragon” hand or the “Tiger” hand, and the deal ends in a tie, then the result is a “push” and the player's stake is simply returned. For any other result, for example if the player wagers on the “Dragon” hand to win and the “Tiger” hand wins, the player's stake is lost to the house.

TABLE 6
“Hand to win” bets

| Result | Payout |
|---|---|
| Win with 17 | Push |
| Win with 18, 19, 20 or 21 | 1 to 1 |
| Tie | Push |
| Win with Blackjack | 3 to 2 |
| Win with >21 (more than 21) | 1 to 2 |

The example payout Table 6 is similar to Table 5, except that if the player wagers 10 dollars on a hand to win, and his selected hand wins with a score of more than 21, then the payout on the 10 dollar bet is 15 dollars (his 10 dollar stake+5 dollars winnings). The other payouts in Table 5 are the same as in Table 4.

Alternative payout tables for “hand to win” bets may be foreseen, such as a payout table similar to table 6, but in which a win or a tie with a blackjack pays out 5 to 2, and a win with over 21 pays out 3 to 2.

Tables 5 and 6 are examples of payout tables for wagers which select one or other of the hands as a winner. Payouts on wagers which select the option “Tie” may be determined by the one of the following Tables 7A to 7D, payout tables A to D:

TABLE 7A
“Tie” bet table A

| Result | Payout |
|---|---|
| Tie at <21 (less than 21) | 7 to 1 |
| Tie at >21 (more than 21) | 7 to 1 |
| Tie at 21 | 9 to 1 |
| Tie with Blackjack | 12 to 1 |

TABLE 7B
“Tie” bet table B

| Result | Payout |
|---|---|
| Tie at <21 (less than 21) | 7 to 1 |
| Tie at >21 (more than 21) | 9 to 1 |
| Tie at 21 | 11 to 1 |
| Tie with Blackjack | 25 to 1 |

TABLE 7C
“Tie” bet table C

| Result | Payout |
|---|---|
| Tie at <21 (less than 21) | 8 to 1 |
| Tie at >21 (more than 21) | 8 to 1 |
| Tie at 21 | 10 to 1 |
| Tie with Blackjack | 13 to 1 |

TABLE 7D
“Tie” bet table D

| Result | Payout |
|---|---|
| Tie at <21 (less than 21) | 7 to 1 |
| Tie at >21 (more than 21) | 7 to 1 |
| Tie at 21 | 13 to 1 |
| Tie with Blackjack | 25 to 1 |

The payout tables for bets on a hand to win and bets on a tie result may be displayed for players to inspect before and during play.

As an alternative to having different payout tables for bets which predict a hand to win and bets which predict a tie, a single comprehensive payout table may be compiled to include payout amounts following any results of the hand for each of the three alternative bets which a player can make.

Once all the winning players have received their payouts, and the stakes of losing players have been collected by the house, play restarts with players making their wagers in preparation for the next deal.

In game play where the dealer performs all of the card manipulations and the players do not touch the playing cards, the cards may be subsequently shuffled and re-dealt, for example by being returned to an automatic card shuffling and dealing device. Alternatively, for example in high limit games in which the players may be permitted to handle or squeeze the cards of the hand on which they have wagered, in order to avoid any suspicion of card tampering, the cards may be destroyed or discarded after each game.

### Example 2

In this example, game play is similar to the example set out above with the following differences:
in the initial deal, each hand receives five cards rather than two;
there is no “dealing tableau” and the cards of the initial hands are unchanged and form the final hands;
the result of the deal is determined by establishing which of the five-card hands forms a poker hand of higher rank.

In a real-world example, the game is played on a casino table similar to that described in relation to Example 1, save that each player position may have a betting area with only two betting regions, corresponding to “hand 1” and “hand 2”. If a pack of more than one deck of 52 cards is being used to play the game and thus the possibility exists that two identical hands may be dealt, or if hand rankings are used that allow two hands of equal rank, then the casino table may be provided with a third betting region for each player, corresponding to “tie”.

Once each player has placed a bet, by for example placing money or gambling chips on a betting region, the dealer alternately deals five cards into each of the dealing areas H1 and H2.

As before, the cards may be dealt face up or face down. If the cards are dealt face up, players can see poker hands building as the deal progresses and their interest and excitement correspondingly builds.

If the cards are dealt face up, then at the end of the deal the dealer makes a determination as to which of the hands forms a poker hand of higher rank, or whether there is a tie.

If the cards are dealt face down, then at the end of the dealing process the dealer will turn over the cards of one of the initial hands in order to reveal their values and determine the highest-ranking poker hand which can be made from those five cards. The dealer then turns over the cards of the other hand, and determines the highest-ranking poker hand which can be made from those five cards. The dealer then determines which hand makes the higher-ranking poker hand, and declares that hand the winner. In the event that both hands have been dealt identical cards, the dealer will declare a tie.

As an alternative to the dealer exposing the cards, a “ceremonial” aspect may be imparted to the game by the dealer dealing the cards face down, and the dealer then inviting selected players to expose the cards of the initial hands. The determination of which player is to be selected to expose the cards of an initial hand may be auctioned among the players, with the highest bidder paying an amount, for example into a prize fund and determining which player will be selected to expose the cards. In a further alternative, the player selected to expose the cards may be determined by the player who has placed the highest wager on that particular hand result. For example, the player who has placed the highest wager on the outcome that the hand dealt into dealing area H1 will win may be the player who will expose the cards of that hand, and the player who has placed the highest wager on the outcome that the hand dealt into dealing area H2 will win may be the player who will expose the cards of that hand. The player who has placed the highest wager may be the player who exposes the cards, or may be given the opportunity to select another player to expose the cards. The round of play concludes by the dealer paying out on winning bets and collecting losing stakes. Payouts may be made in accordance with a payout table which determines a different return on a player's stake in dependence on the cards revealed in play. For example, if a player bets on hand 1 to win, and hand 1 wins with a royal flush then the player may win more than he would if hand 1 had won with, say, a pair of Jacks.

### Example 3

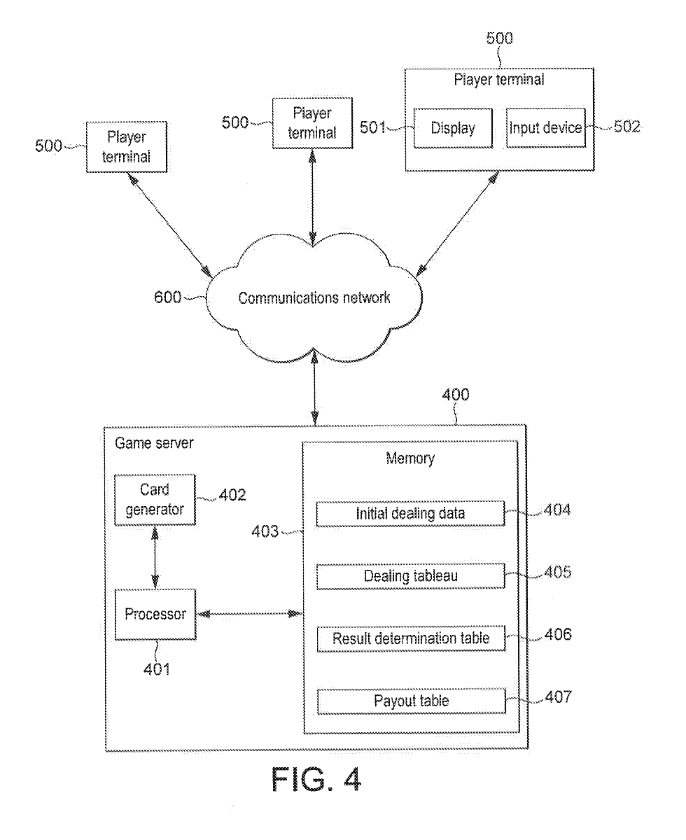

In this example the game is played using an electronic gaming system illustrated schematically in FIG. 4.

In the system illustrated in FIG. 4, a game server 400 is linked to a number of player terminals 500 by a communications network 600 such as the Internet.

Each player terminal 500 comprises a display 501 for displaying cards and information to a player, and input means 502 to enable a player to place a wager by indicating a predicted result and a wager amount. The input means 502 may be a conventional keyboard, or maybe a touch-screen device or a specialized keyboard adapted for inputting wager amounts and predicted results.

The game server 400 comprises a processor 401, a card generator 402 and a memory 403.

The processor 401 is in overall control of the game, based on instructions stored in the memory 403.

The random card generator 401 operates to generate random card values, when requested by the processor 401. Card values may be generated entirely at random, enabling duplicate cards to be dealt to the same hand or to the two hands in play. Alternatively the card generator may be arranged such that during each deal it makes a random selection from as yet un-dealt cards of a standard deck.

The memory 403 stores initial dealing data 404 which indicates the number of cards to be dealt to each of the two initial hands in the game. Depending on the game being played, the initial dealing data 404 may indicate for example that 2 cards are dealt to each hand, or that 5 cards are dealt to each hand. The memory 403 also stores a dealing tableau 405 which determines whether and how each initial hand is modified in order to reach the final hand in each round.

The memory 403 also includes a result determination table 406, which is a look-up table which correlates the individual scores, or alternatively the combination of cards, of the two final hands and the determined result of the deal. Alternatively, the result may be determined not by a look-up table, but by an algorithm into which the scores of the two final hands are input and which then calculates and outputs the result of the deal. Such an algorithm may comprise a set of instructions for carrying out the method steps 190 to 196 described in relation to FIG. 2.

The memory 403 further includes one or more payout tables 407 which determine the amounts to be paid out to players on the basis of the result predicted by the player, the amount wagered, and the determined result of the deal.

To play the game using the apparatus of FIG. 4, each player at a player terminal 500 inputs bet data comprising a predicted result and a wager amount, using the input means 502. The bet data is communicated to the game server 400 via the communications network 600, and is stored in memory 403.

When the processor 401 determines that all players have placed their respective wagers, the processor 401 retrieves the initial dealing data 404 from the memory 403 to determine how many cards are to be dealt, and requests the card generator 402 to generate card data representing sufficient cards to form two hands with the required number of cards each. In this example, four cards are generated by the card generator 402 and communicated to the processor 401. If the apparatus only offers games in which the initial deal is of four cards, then the step of retrieving initial dealing data may be omitted and the processor may simply request the card generator 402 to generate card data defining four playing cards. The processor 401 then sends the card data to the player terminals 500, where the cards are displayed on the displays at the player terminals as two hands of two cards each.

Processor 401 then determines the value of the two cards of a first one of the hands, and retrieves from the dealing tableau 405 instructions as to whether a further card is to be added to that hand, or whether the hand can stand. If a further card is required, processor 401 requests card generator 402 to randomly generate card data representing a further card, and processor 401 communicates this card data to the player terminals 500 which then display the additional card as an addition to the first hand. When the total of the first hand is such that the dealing tableau indicates that no further cards are to be drawn, the final value of the first hand is established.

Processor 401 then determines the value of the cards of the other hand, and based on the instructions in the dealing tableau 405 determines whether further cards are to be drawn. If a further card is required, processor 401 requests card generator 402 to randomly generate card data representing a further card, and processor 401 communicates this card data to the player terminals 500 which then display the additional card as an addition to the second hand, until the total of the second hand is such that the dealing tableau indicates that no further cards are to be drawn and the final value of the second hand is established.

The processor 401 then determines the result of the deal by looking up the determined result in the result determination table 406 on the basis of the final values of the two hands. Result data, representing the determined result of the deal may then be sent by the processor 401 to the player terminals 500 for display to the players.

The processor 401 then retrieves from memory 403 the bet data received from each player terminal, and compares the result predicted by the player with the determined result, and on the basis of this comparison and information retrieved from the payout table 407 and the amount of the player's wager sends an indication to the respective player terminal of the player's winnings or loss.

Each player terminal 500 may include in its display 501 a field which shows a running total value of a player's account, this value being reduced as the player places a wager, and increased as the player receives winnings or has his stake returned at the end of each deal.

When all the wagers have been resolved at the end of a deal, the processor 401 may then initiate another round of play by causing each player terminal 500 to show on its display 501 and invitation to the player to place his wager for the next game.

In an alternative embodiment of the gaming system, the processor 401 operates the card generator to generate two hands of five cards, and no dealing tableau is used but the two hands of cards are regarded as the final hands. The processor 401 then determines the result of the deal, by assigning a rank to each of the two hands of cards, and determining which hand has the higher rank. The hand with the higher rank is determined to be the winner. The result of the deal may also be determined to be a tie, if the two hands have the same rank.

The processor may determine the result of the deal by looking up the result in a result determination table 406, which stores a numerical value for each possible combination of five cards, the numerical value representing the rank to be assigned to that combination of five cards. The rank may be based on poker hand ranking, and may represent the highest-ranked poker hand which can be formed from those five cards. The processor 401 retrieves from the table a numerical value corresponding to each of the two hands, and compares the numerical values to determine the winning hand.

As an alternative to using conventional poker hand rankings, the result determination table 406 may assign a rank to each different combination of five playing cards, but the ranks may be assigned in groups so that, for example, each combination of five cards which does not include a pair will form a group of hands having the same rank. Other examples of groups of hands with the same rank may be: combinations of five cards in which there are no picture cards and no even-numbered cards; combinations of five cards in which there are no picture cards and no odd-numbered cards; combinations of five cards in which all of the cards are of the same color (but not necessarily the same suit). The result determination table 406 may have some of the rank values assigned to 5-card combinations on the basis of poker hand rankings, and others of the rank values assigned on the basis of other characteristics of the five-card combination.

The player terminal 500 may be a desktop or laptop computer, or may be a pad computer or mobile telephone apparatus or any other mobile communications apparatus connectable to the communications network.

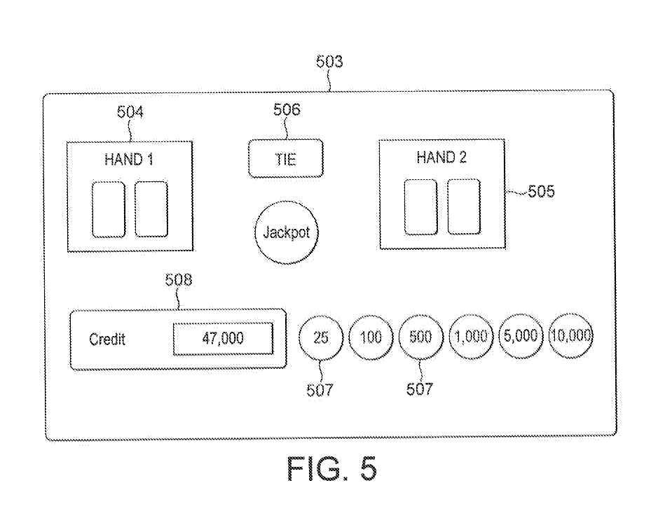

A typical display for a player terminal is shown in FIG. 5. The display 501 includes a screen 503, having a “Hand 1” field 504 in which the cards of a first hand will be displayed, and a “Hand 2” field 505 in which the cards of the second hand will be displayed in. These fields may be blank at the start of play, until the player indicates that he wishes to participate in the game by placing a wager. Alternatively, the fields 504 and 505 may display the backs of a number of cards. The screen may display a message inviting the player to place a wager.

The screen 503 may be a touch-screen device operable as an input, and touching one of the “Hand 1” field 504 or the “Hand 2” field 505 may input bet data indicating a bet on the selected hand. The screen may further include a “Tie” field 506, and touching this field may indicate a bet on the result “tie”. The display may further include one or more amount fields 507, which a player may touch to indicate an amount of a wager. An “account total” field 508 may display the running total of the player's credit available for play.

To initiate play, the player will input bet data comprising a selection of the “Hand 1” field 504, the “Hand 2” field 505 or the “Tie” field 506. The player will then input a selected amount by means of one of the fields 507. The input may be made by touching the screen on a touch screen device, or by indicating the particular field using a mouse click or other input needs.

Once the bet data has been input, the player's running total in the field 508 will be decreased by the amount of the wager, and the faces of cards will be displayed in the fields 504 and 505 representing the two initial hands dealt. The cards displayed in the fields 504 and 505 will then be modified in accordance with the dealing tableau, and additional cards may appear in either or both of the fields until the final hands are reached.

The result of the deal will then be determined, and depending on the player's selected wager, a congratulatory or commiseratory message may be displayed on the screen. Any payout due to the player will then be calculated on the basis of the appropriate payout table, and the total in the field 508 will be adjusted to show the player's winnings.

The display will then revert to an invitation to the player to place a bet and initiate a further round of play.

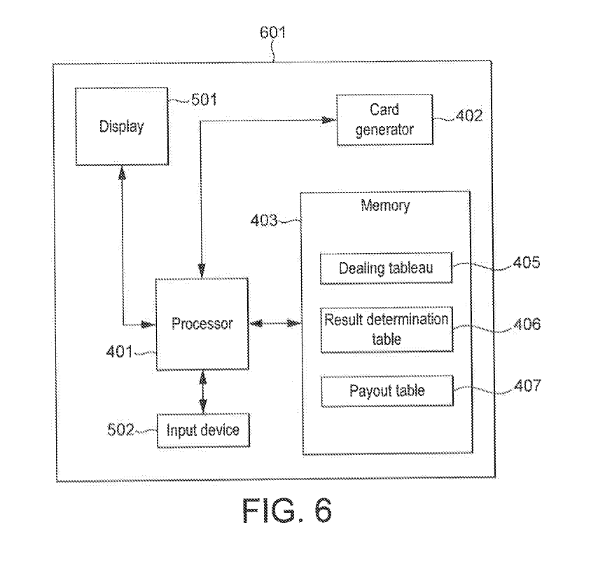

FIG. 6 illustrates an alternative apparatus for playing the game of the present disclosure, embodied as a stand-alone gaming apparatus 601. This apparatus essentially includes the features of the game server 400 of FIG. 4 and the features of the player terminal 500 of FIG. 4. In the apparatus of FIG. 6, the processor 401 receives bet data from the player via the input device 502. The processor 401 then requests card generator 402 to generate cards for the two hands to be played, and displays the hands on the display 501. As described in relation to the FIG. 4 embodiment, processor 401 then applies the rules of the dealing tableau 405 to the two hands of cards, and determines the result of the deal by referring to the result determination table 406. The processor then compares the bet data with the determined result, and determines the player's winnings with reference to the payout table 407. The result of the deal is displayed on the display 501. The apparatus may further include means for establishing a credit balance for the player at the terminal and displaying the credit balance on the screen. The apparatus may further include means to increment the credit balance, such as a credit card reader or cash acceptor for inputting credit to the machine. In order for the player to be able to collect winnings, the apparatus may further include a cash payout device or means to credit a player's bank account via a credit card reader or the like.

The payout tables for bets on a hand to win and bets on a tie result may be made available for players to inspect before and during play, and may be displayed on request at terminals of on-line gamers. The terminal or gaming machine display screen may include a field which, when selected, provides a display on the screen of some or all of the payout table in use in the game. Alternatively, the payout amounts may be displayed on the display screen either permanently or intermittently, for example the payout amounts may be displayed during the time the player has available to place a wager.

The above examples of the present disclosure provide a hybrid card game with increased player appeal and excitement of card game play.

The above example and embodiments have been described by way of example only and modifications are possible within the scope of the claims that follow.

What is claimed is:

1. A method of playing a wagering card game by at least one player, comprising:
the player placing a wager by choosing an amount of the wager, and selecting from a first hand to win, a second hand to win, and the result to be a tie;
dealing a first hand of two cards and a second hand of two cards from a pack of playing cards;
determining the total value of the two cards of the first hand;
if the total value of the cards in the first hand is less than a predetermined threshold value, dealing one or more further cards to the first hand until the total equals or exceeds the threshold value;
establishing the final total value of the cards of the first hand;
if the total value of the cards in the second hand is less than a predetermined threshold value, dealing one or more further cards to the second hand until the total equals or exceeds the threshold value;
establishing the final total value of the cards of the second hand; and
determine the result of the deal, such that:
if the final totals of the first and second hands are equal, determine that the result is a tie;
if the final total of the first hand is 21 or fewer, and is more than that of the second hand, determine that the first hand is the winner;
if the final total of the first hand is 21 or fewer, and the final total of the second hand is 22 or more, determine that the first hand is the winner;
if the final total of the second hand is 21 or fewer, and is more than that of the first hand, determine that the second hand is the winner;
if the final total of the second hand is 21 or fewer, and the final total of the first hand is 22 or more, determine that the second hand is the winner; and
if both the first hand and the second hand have final totals of more than 21, determine that the hand with the lower total is the winner;
settling the player's wager on the basis of the determination.

2. The method of claim 1, wherein in the step of determining the result of the deal, if the final totals of the first and second hands are both 21 and only one of the hands consists of an ace and a picture card, then determining that the hand having the ace and the picture card is the winner.

3. The method of claim 1, wherein the step of dealing a first hand of two cards and a second hand of two cards comprises placing physical playing cards forming the first hand on a first dealing area of a game table, and placing physical playing cards forming the second hand on a second dealing area of a game table.

4. The method of claim 1, wherein the step of placing a wager comprises placing a coin, banknote or gambling chip in a designated betting region of a game table.

5. The method of claim 1, wherein the step of dealing one or more further cards to the first hand or to the second hand comprises placing physical playing cards in the respective dealing areas of the first hand and the second hand.

6. The method of claim 1, wherein the predetermined threshold value is 17.

7. The method of claim 1, wherein the pack of playing cards comprise one or more standard decks of playing cards.

8. The method of claim 7, wherein the value of each card is its face value, picture cards having a value of 10 and aces having a value selected from 1 and 11.

9. The method of claim 1, wherein the first hand and the second hand are referred to by using names selected from the group comprising:
“Dragon” and “Tiger”;
“Gold” and “Silver”;
“Diamonds” and “Pearls”; and
“Yin” and “Yang”.

10. The method of claim 1, wherein the step of settling the player's wager comprises determining whether the selection made by the player coincides with the determined result, and paying winnings to the player on the basis of that determination, the amount of the wager and a predetermined payout table.

11. The method of claim 3, wherein the step of paying winnings to the player comprises placing coins, banknotes or gambling chips in the designated betting region of the game table.

12. A method of playing a wagering card game by at least one player, comprising:
the player making a wager by choosing from a first hand to win and a second hand to win, and choosing an amount of the wager;
dealing a first hand of five cards and a second hand of five cards from a pack of playing cards;
determining a rank of the hand formed by the cards of the first hand;
determining a rank of the hand formed by the cards of the second hand;
determining the result of the deal on the basis of the hand rankings, such that:
if the hand formed by the cards of the first hand is higher in rank than the hand formed from the cards of the second hand, declaring the first hand as the winner; or
if the hand formed by the cards of the first hand is lower in rank than the hand formed by the cards of the second hand, declaring the second hand as the winner; and
settling the player's wager on the basis of the determination.

13. The method of claim 12, wherein the step of settling the player's wager comprises determining whether the selection made by the player coincides with the determined result, and paying winnings to the player on the basis of that determination and the amount of the wager and a predetermined payout table.

14. The method of claim 12, wherein the ranks of hands which can be formed from the cards of the first and second hands are determined by poker hand ranking.

15. The method of claim 14, wherein:
the step of determining the rank of the hand formed from the cards of the first hand comprises determining the highest-ranking poker hand that can be formed by the cards of the first hand; and
the step of determining the rank of the hand formed from the cards of the second hand comprises determining the highest-ranking poker hand that can be formed by the cards of the second hand.

16. The method of claim 12, wherein the ranks of the first and second hands are determined by reference to a hand ranking table which sets out a hand ranking corresponding to each combination of cards forming a hand.

17. A gaming machine, comprising:
a display screen for displaying hands of cards to a player;
an input operable to allow a player to input betting information comprising an amount of a wager and a prediction either that a first hand will win, that a second hand will win, or that the result will be a tie;
a memory operable to store the betting information and a predetermined threshold value;
a control unit including a processor operable to:
receive the betting information and store it in the memory;
randomly generate two hands of two cards, in response to receiving betting information;
display the two hands on the display screen;
determine the total value of the two cards of the first hand;
if the total value of the two cards of the first hand is less than the predetermined threshold value, generate a further card and add it to the first hand, repeating this step until the total value of the cards in the first hand equals or exceeds the predetermined threshold value;
determine the final total value of the cards of the first hand;
if the total value of the two cards of the second hand is less than the
predetermined threshold value, generate a further card and add it to the second hand, repeating this step until the total value of the cards in the second hand equals or exceeds the predetermined threshold value;
determine the final total value of the cards of the second hand; and
determine the result of the deal, such that:
if the final totals of the first and second hands are equal, determine that the result is a tie;
if the final total of the first hand is 21 or fewer, and is more than that of the second hand, determine that the first hand is the winner;
if the final total of the first hand is 21 or fewer, and the final total of the second hand is 22 or more, determine that the first hand is the winner;
if the final total of the second hand is 21 or fewer, and is more than that of the first hand, determine that the second hand is the winner;
if the final total of the second hand is 21 or fewer, and the final total of the first hand is 22 or more, determine that the second hand is the winner; and
if both the first hand and the second hand have final totals of more than 21, determine that the hand with the lower total is the winner;
display the determined result of the deal;
determine an amount of winnings payable to the player based on the determined result of the deal, the result predicted by the player, and the amount of the wager; and
communicate the amount of winnings to the player, via the display screen.

18. The gaming machine of claim 17, wherein the processor is operable to determine the result of the deal such that, if the final totals of the first and second hands are both 21 and only one of the hands consists of an ace and a picture card, then determining that that the hand having the ace and the picture card is the winner.

19. The gaming machine of claim 17, wherein:
the memory further stores a correlation table providing a correlation between the final totals of the cards in the hands and the result of the deal; and
the processor is operable to determine the result of the deal on the basis of the final totals of the cards and the correlation table.

20. The gaming machine of claim 17, wherein:
the memory further includes an algorithm relating the final totals of the cards to the determined result of the deal; and
the processor is operable to determine the result of the deal on the basis of the final totals of the cards by applying the stored algorithm to the final totals.

21. The gaming machine of claim 17, wherein:
the memory further stores a payout table providing a correlation between:
the player's prediction;
the determined result of the deal;
the final totals of the cards in the hands, and
an amount to be paid to a winning player;
and
the processor is operable to determine the amount of winnings on the basis of the predicted result of the deal, the final totals of the cards in the hands, the determined result of the deal and the amount of the wager.

22. The gaming machine of claim 17, wherein the predetermined threshold is 17.

23. A gaming machine, comprising:
a display screen operable to display hands of cards to a player;
an input operable to receive input betting information comprising an amount of a wager and a prediction either that a first hand will win, or that a second hand will win;
a memory operable to store the betting information;
a control unit including a processor operable to:
receive the betting information and store it in the memory;
randomly generate to two hands of five cards, in response to receiving betting information;
display the two hands on the display screen;
determine a rank for the first hand;
determine a rank for the second hand;
determine the result of the deal on the basis of the hand ranks, such that:
if the first hand is higher in rank than the second hand, declaring the first hand as the winner; or
if the first hand is lower in rank than the second hand, declaring the second hand as the winner;
display the determined result of the deal;
determine an amount of winnings payable to the player based on the determined result of the deal, the result predicted by the player, and the amount of the wager; and
communicate the amount of winnings to the player, via the display screen.

24. The gaming machine of claim 23, wherein:
the input is operable to receive input betting information comprising a prediction that the result will be a tie; and
in the step of determining the result of the deal, the processor is further operable to declare the result to be a tie if the rank of the first hand is equal to that the second hand.

25. The gaming machine of claim 23, wherein:
the memory further stores a table in which each combination of five playing cards from a standard deck is allocated a rank, and
the processor is operable to determine the result of the deal by retrieving from the table the ranks ascribed to the combinations of playing cards which form the first and second hands, and comparing the retrieved ranks.

26. The gaming machine of claim 25, wherein each combination of five playing cards is ascribed a rank which reflects the highest-ranked poker hand which can be formed from those five cards.

27. A gaming system comprising a gaming server and a plurality of gaming terminals, the gaming server and the said plurality of gaming terminals being linked by a communications network, wherein each of the gaming terminals comprises:
a display screen operable to display two hands of cards to a player; and
input operable to receive betting information comprising a selection of a first hand to win, a second hand to win, or the result to be a tie, and selecting an amount of the wager;
and wherein the gaming server comprises:
a card generator for generating card data representing randomly-selected playing cards;
a memory in which are stored:
a dealing tableau consisting of instructions for modifying an initial hand of cards to form a final hand of cards; and
a payout table storing correlations between a determined result, a predicted result, an amount of a wager, and an amount to be paid; and
a processor operable to:
receive betting information from at least one player terminal;
cause the card generator to generate card data for two initial hands of cards;
transmit card data for the initial hands of cards to the gaming terminals for display;
modify the initial hands of cards on the basis of instructions in the dealing tableau to form to final hands of cards;
transmit card data for the final hands of cards to the gaming terminals for display;
determine a result of the deal, such that;
if the final totals of the first and second hands are equal, determine that the result is a tie;
if the final total of the first hand is 21 or fewer, and is more than that of the second hand, determine that the first hand is the winner;
if the final total of the first hand is 21 or fewer, and the final total of the second hand is 22 or more, determine that the first hand is the winner;
if the final total of the second hand is 21 or fewer, and is more than that of the first hand, determine that the second hand is the winner;
if the final total of the second hand is 21 or fewer, and the final total of the first hand is 22 or more, determine that the second hand is the winner; and
if both the first hand and the second hand have final totals of more than 21, determine that the hand with the lower total is the winner;
settle each player's wager on the basis of the predicted result, the amount of the wager, the determined result and the payout table.

28. The gaming system of claim 27, wherein the processor is operable to determine the result of the deal such that, if the final totals of the first and second hands are both 21 and only one of the hands consists of an ace and a picture card, then determining that the hand having the ace and the picture card is the winner.

29. The gaming system of claim 27, wherein:
the memory of the gaming server stores a result determination table correlating a result of the deal and the values of final hands of the cards; and
the processor is operable to determine the result of the deal on the basis of the values of the final hand and the result determination table.

30. A gaming system comprising a gaming server and a plurality of gaming terminals, the gaming server and the said plurality of gaming terminals being linked by a communications network, wherein each of the gaming terminals comprises:
a display screen operable to display two hands of cards to a player; and
an input operable to receive input betting information comprising a selection from a first hand to win and a second hand to win, and selecting an amount of the wager;
and wherein the gaming server comprises:
a card generator for generating card data representing randomly-selected playing cards;
a memory in which are stored:
a result determination table for determining a result of the deal based on hand rankings; and
a payout table storing correlations between a determined result, a predicted result, and an amount to be paid;
and a processor operable to:
receive betting information from at least one player terminal;
cause the card generator to generate card data for respective first and second hands of five cards;
transmit card data for the hands of cards to the gaming terminals for display;
determine a rank for the first hand;
determine a rank for the second hand;
determining the result of the deal on the basis of hand rankings; and
settle the player's wager on the basis of the predicted result, the amount of the wager, the determined result and the payout table.

31. The gaming system of claim 30, wherein the processor is operable to determine the result of the deal on at least the basis that:
if the highest-ranked poker hand which can be formed from the cards of the first hand is higher in rank than highest-ranked poker hand which can be formed from the cards of the second hand, declaring the first hand as the winner; or
if the highest-ranked poker hand which can be formed from the cards of the first hand is lower in rank than highest-ranked poker hand which can be formed from the cards of the second hand, declaring the second hand as the winner; or
if the highest-ranked poker hand which can be formed from the cards of the first hand is equal in rank to highest-ranked poker hand which can be formed from the cards of the second hand, declaring the result to be a tie.

32. The gaming system of claim 30, wherein the result determination table stores a rank for each combination of five playing cards, and wherein the processor is operable to determine the result of the deal by retrieving from the table the ranks ascribed to the combinations of playing cards which form the first and second hands, and comparing the retrieved ranks.

33. The gaming system of claim 32, wherein each combination of five playing cards is ascribed a rank which reflects the highest-ranked poker hand which can be formed from those five cards.

34. A non-transitory computer readable medium including instructions that, when executed by a processor, enables a gaming machine to provide to at least one player a wagering card game comprising the steps of:
receiving bet data representing a player's wager, the bet data comprising a selection of a first hand to win, a second hand to win, or the result to be a tie, and selecting an amount of the wager, from a player at a player terminal;
generating a first hand of two cards and a second hand of two cards and displaying the two hands of cards at the player terminal;
determining the total value of the two cards of the first hand;
if the total value of the two cards in the first hand is equal to or less than a predetermined threshold value, generating further cards and adding them to the first hand until the total value of the cards in the first hand exceeds the predetermined threshold value;
determining the final total value of the cards of the first hand;
if the total value of the two cards in the second hand is equal to or less than a predetermined threshold value, generating further cards and adding them to the second hand until the total value of the cards in the second hand exceeds the predetermined threshold value;
determine the result of the deal, such that:
if the final totals of the first and second hands are equal, determine that the result is a tie;
if the final total of the first hand is 21 or fewer, and is more than that of the second hand, determine that the first hand is the winner;
if the final total of the first hand is 21 or fewer, and the final total of the second hand is 22 or more, determine that the first hand is the winner;
if the final total of the second hand is 21 or fewer, and is more than that of the first hand, determine that the second hand is the winner;
if the final total of the second hand is 21 or fewer, and the final total of the first hand is 22 or more, determine that the second hand is the winner; and
if both the first hand and the second hand have final totals of more than 21, determine that the hand with the lower total is the winner; and
settling the player's wager on the basis of the determined result of the deal and the bet data.

35. The medium of claim 34, wherein the software comprises a program which, when executed by the processor, enables the gaming machine to determine the result of the deal such that, if the final totals of the first and second hands are both 21 and only one of the hands consists of an ace and a picture card, then the hand having the ace and the picture card is the winner.

36. The medium of claim 34, wherein the predetermined threshold value is 17.

37. A non-transitory computer readable medium including instructions that, when executed by a processor, enables a gaming machine to provide to at least one player a wagering card game comprising the steps of:
receiving bet data representing a player's wager, the bet data comprising a selection of a first hand to win or a second hand to win, and selecting an amount of the wager, from a player at a player terminal;
generating a first hand of five cards and a second hand of five cards and displaying the two hands of cards at the player terminal;
determining the highest-ranked poker hand which can be formed from the five cards of the first hand;
determining the highest-ranked poker hand which can be formed from the five cards of the second hand;
determining the result of the deal on the basis of poker hand rankings, such that:
if the highest-ranked poker hand which can be formed from the cards of the first hand is higher in rank than highest-ranked poker hand which can be formed from the cards of the second hand, declaring the first hand as the winner; or
if the highest-ranked poker hand which can be formed from the cards of the first hand is lower in rank than highest-ranked poker hand which can be formed from the cards of the second hand, declaring the second hand as the winner; and
settling the player's wager on the basis of the determined result of the deal and the bet data.

38. A gaming table for playing the card game of claim 1, the gaining table comprising:
a dealer position intermediate the length of a first side of the table;
first and second card dealing areas delineated on the table adjacent the dealer position, to receive first and second hands of cards, respectively;
a number of player positions spaced along a second side of the table opposite the first side;
a respective betting area delineated on the table adjacent each of the player positions, each betting area being divided into three betting regions;
a first one of the three betting regions being provided with an indicium relating to the first card dealing area;
a second one of the three betting regions being provided with an indicium relating to the second card dealing area; and
a third one of the three betting regions being provided with an indicium signifying a tie.

39. The gaming table of claim 38, wherein the table is generally semicircular and has a straight first side and an arcuate second side.

40. The gaming table of claim 38, wherein the indicium relating to the first card dealing area represents a dragon, and wherein the indicium relating to the second card dealing area represents a tiger.

41. A method of playing a wagering card game by at least one player, using a gaming apparatus comprising:
one or more decks of playing cards;
a card shuffling and dealing apparatus;
a gaming table having delineated thereon:
first and second card dealing areas;
a number of player positions;
a respective betting area delineated adjacent each of the player positions, each betting area being divided into three betting regions, and each betting region being associated with a respective game outcome; and
tokens for representing the value of a wager;
the method comprising:
the player placing a wager on a possible game outcome, by positioning a number of tokens to the amount of the wager in a betting region associated with the player's selected game outcome;
delivering, from the shuffling and dealing apparatus, a first hand of two cards and a second hand of two cards from a pack of playing cards;
placing the first hand in the first card dealing area and placing the second hand in the second card dealing area;
determining the total value of the two cards of the first hand;
if the total value of the cards in the first hand is less than a predetermined threshold value, delivering one or more further cards from the shuffling and dealing apparatus, and placing them in the first card dealing area until the total value of the cards in the first hand equals or exceeds the threshold value;
establishing the final total value of the cards of the first hand;
if the total value of the cards in the second hand is less than a predetermined threshold value delivering one or more further cards from the shuffling and dealing apparatus, and placing them in the second card dealing area until the total value of the cards in the second hand equals or exceeds the threshold value;
establishing the final total value of the cards of the second hand; and determine the outcome of the deal, such that:
if the final totals of the first and second hands are equal, determine that the outcome is a tie;
if the final total of the first hand is 21 or fewer, and is more than that of the second hand, determine that the outcome is that the first hand is the winner;
if the final total of the first hand is 21 or fewer, and the final total of the second hand is 22 or more, determine that the outcome is that the first hand is the winner;
if the final total of the second hand is 21 or fewer, and is more than that of the first hand, determine that the outcome is that the second hand is the winner;
if the final total of the second hand is 21 or fewer, and the final total of the first hand is 22 or more, determine that the outcome is that the second hand is the winner; and
if both the first hand and the second hand have final totals of more than 21, determine that the outcome is that the hand with the lower total is the winner;
settling the player's wager, on the basis of the determination of the outcome of the deal, by either:
placing a number of additional tokens in the betting area in which the tokens forming the wager were positioned;
removing the tokens positioned in the betting area by the player; or
returning to the player the tokens positioned in the betting area by the player.

42. The method of claim 41, wherein the gaming apparatus further comprises a payout table correlating:
the outcome on which the player wagered;
the determined outcome of the deal; and
an amount of winnings to be paid to a player;
and wherein settling the player's wager comprises determining the amount of winnings to be paid on at least the basis of the outcome of the deal, the outcome on which the player wagered, the amount of the wager and the corresponding amount set out in the payout table.

43. The method of claim 41, wherein the threshold value is 17.
